(19) United States
(12) Patent Application Publication
(10) Pub. No.: US 2023/0032372 A1
(43) Pub. Date: Feb. 2, 2023

(54) GENERATION DEVICE, GENERATION METHOD, AND GENERATION PROGRAM

(71) Applicant: NIPPON TELEGRAPH AND TELEPHONE CORPORATION, Tokyo (JP)

(72) Inventors: Atsunori OGAWA, Musashino-shi, Tokyo (JP); Naohiro TAWARA, Musashino-shi, Tokyo (JP); Shigeki KARITA, Musashino-shi, Tokyo (JP); Marc DELCROIX, Musashino-shi, Tokyo (JP)

(73) Assignee: NIPPON TELEGRAPH AND TELEPHONE CORPORATION, Tokyo (JP)

(21) Appl. No.: 17/790,528

(22) PCT Filed: Jan. 22, 2020
(86) PCT No.: PCT/JP2020/002193

§ 371 Date: Jul. 1, 2022

(51) Int. Cl. G06F 40/56; G06F 40/51; G06F 40/216

(52) U.S. Cl. CPC G06F 40/56; G06F 40/51; G06F 40/216

(57) ABSTRACT

The extraction unit 132 extracts a second word corresponding to a first word included in a first text from among a plurality of words belonging to a predetermined domain. The determination unit 133 determines whether a predetermined condition for the word class of the first word is satisfied or not. When it is determined by the determination unit 133 that the condition is satisfied, the generation unit 134 generates a second text in which the first word of the first text is exchanged with the second word.

### TECHNICAL FIELD

The present invention relates to a generation apparatus, a generation method and a generation program.

### BACKGROUND ART

Speech recognition by a neural network is known. In speech recognition, an acoustic model and a language model are used. Since speech recognition is essentially a highly domain-dependent technology, it may be difficult to, in domains with few available resources such as natural utterance, a minor language or the like, secure especially text to be learning data for a language model.

To cope with this, for example, a method of collecting text data related to a target domain by web search and a method of using a large amount of text data of another domain which has sufficient resources, in addition to a small amount of text data of a target domain (see, for example, Non-Patent Literature 1 or 2) are known as methods for obtaining learning data for a language model.

### CITATION LIST

### Non-Patent Literature

Non-Patent Literature 1: A. Stolcke, “SRILM—An extensible language modeling toolkit,” in Proc. ICSLP, 2002, pp. 901-904.
Non-Patent Literature 2: B.-J. Hsu, “Generalized linear interpolation of language models,” in Proc. ASRU, 2007, pp. 549-552.

### SUMMARY OF THE INVENTION

### Technical Problem

The conventional methods, however, have a problem that there may be a case where it is difficult to reinforce learning data so as to enhance accuracy of a language model. For example, the method of collecting text data related to a target domain by web search has a problem that it is necessary to carefully format collected data. Further, the method of using a large amount of text data of another domain that has sufficient resources has a problem that the effect depends on how close a target domain and the other domain are to each other.

### Means for Solving the Problem

In order to solve the above problem and achieve an object, a generation apparatus includes: an extraction unit extracting a second word corresponding to a first word included in a first text from among a plurality of words belonging to a predetermined domain; a determination unit determining whether a predetermined condition for a word class of the first word is satisfied or not; and a generation unit generating a second text in which the first word of the first text is exchanged with the second word when it is determined by the determination unit that the condition is satisfied.

### Effects of the Invention

According to the present invention, it is possible to perform such reinforcement of learning data that enhances accuracy of a language model.

### BRIEF DESCRIPTION OF DRAWINGS

FIG. 1 is a diagram showing a configuration example of a generation apparatus according to a first embodiment.

FIG. 2 is a diagram illustrating a flow of a process of the generation apparatus according to the first embodiment.

FIG. 3 is a diagram illustrating bidirectional LSTM.

FIG. 4 is a diagram illustrating determination of conditions.

FIG. 5 is a diagram showing examples of an input sentence and an output sentence.

FIG. 6 is a flowchart showing the flow of the process of the generation apparatus according to the first embodiment.

FIG. 7 is a flowchart showing a flow of a sentence generation process.

FIG. 8 is a diagram showing a result of an experiment.

FIG. 9 is a diagram showing details of datasets.

FIG. 10 is a diagram showing a configuration example of a generation apparatus according to a second embodiment.

FIG. 11 is a flowchart showing a flow of a process of the generation apparatus according to the second embodiment.

FIG. 12 is a diagram illustrating the flow of the process of the generation apparatus according to the second embodiment.

FIG. 13 is a diagram showing an example of a computer to execute a generation program.

### DESCRIPTION OF EMBODIMENTS

Embodiments of a generation apparatus, a generation method and a program according to the present application will be explained below in detail based on drawings. The present invention is not limited to the embodiments explained below.

In each of the embodiments below, a word string in which words are arranged will be called a sentence or text. Further, the number of words included in a sentence will be defined as the length of the sentence. Further, a position at which a word appears in a sentence will be defined as time. For example, since a sentence “Watashi (I) wa [particle] ryori (cooking) ga [particle]suki (like)” is configured with five words, the length is 5. A word at time 1 in the sentence is “Watashi (I)”. A word at time 2 in the sentence is “wa [particle]”. A word at time 3 in the sentence is “ryori (cooking)”. Further, a word in a sentence is identified by morphological analysis or the like.

Here, in each embodiment, sentences and words are classified into domains. For example, a domain classification method may be based on content of sentences, such as themes and fields or may be based on sentence styles such as a casual style (da/dearu [auxiliary verb] tone), a formal style (desu/masu [auxiliary verb] tone), a lecture style, a message style and a conversation style. Further, the domain classification method may be a combination of the above bases.

Furthermore, domains may be replaced with “styles”, “categories” or the like. Further, domains may be such that are manually classified or may be such that are automatically classified using a model for classification.

The generation apparatus of each embodiment is intended to reinforce learning data of a predetermined domain. The generation apparatus generates text of a second domain with text of a first domain as an input. For example, in a case where it is not possible to sufficiently prepare text of the second domain, the generation apparatus generates text of the second domain using text of the first domain that is available in large amounts. Furthermore, by adding the generated text to learning data, the generation apparatus can reinforce the learning data and contribute to accuracy enhancement of a language model of the second domain.

The generation apparatus of each embodiment converts the domain of text without a teacher. In the present specification, it is assumed that “without a teacher” means that text of a conversion destination domain to be paired with text of a conversion source domain is not used. Thereby, according to the generation apparatus, it is possible to reinforce text data of a domain for which it is difficult to obtain text data, based on text of a domain for which a large amount of text exists.

A language model is, for example, N-gram, a neural network or the like. N-gram is such that, on the assumption that, in a sentence, the probability of appearance of a word at certain time is determined depending on N−1 words in the past, the probability of appearance of each word at certain time is modeled based on a result of performing morphological analysis of a large number of digitized sentences. A model depending on one word in the past (N=2) is called bigram. Further, a model depending on two words in the past (N=3) is called trigram. N-gram is a generic term of these.

### FIRST EMBODIMENT

### Configuration of First Embodiment

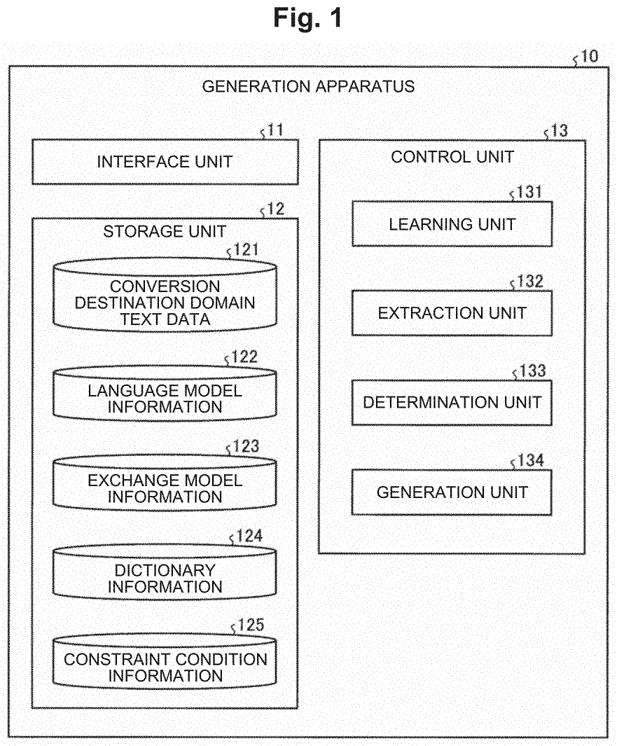

First, a configuration of a generation apparatus according to a first embodiment will be explained using FIG. 1. FIG. 1 is a diagram showing a configuration example of the generation apparatus according to the first embodiment. As shown in FIG. 1, a generation apparatus 10 has an interface unit 11, a storage unit 12 and a control unit 13.

The interface unit 11 is an interface for input/output of data. The interface unit 11 accepts input of data, for example, via an input device such as a mouse and a keyboard. Further, the interface unit 11 outputs data, for example, to an output device such as a display.

The storage unit 12 is a storage device such as an HDD (hard disk drive), an SDD (solid state drive) or an optical disk. The storage unit 12 may be a data-rewritable semiconductor memory such as a RAM (random access memory), a flash memory or an NVSRAM (non-volatile static random access memory). The storage unit 12 stores an OS (operating system) and various kinds of programs to be executed in the generation apparatus 10. The storage unit 12 stores conversion destination domain text data 121, language model information 122, exchange model information 123, dictionary information 124 and constraint condition information 125.

The conversion destination domain text data 121 is a set of texts classified in a conversion destination domain. The conversion destination domain may be a domain for which it is difficult to collect text.

The language model information 122 is parameters and the like for constructing a language model such as N-gram. The exchange model information 123 is parameters and the like for constructing an exchange model to be described later. If an exchange model is a bidirectional LSTM (long short-term memory), the exchange model information 123 is the weight of each layer, and the like.

The dictionary information 124 is data in which indexes are attached to words. The dictionary information 124 includes words of both of conversion source and conversion destination domains.

The constraint condition information 125 is condition for determining whether or not to use a certain word for generation of a sentence of the conversion destination domain. The constraint condition information 125 includes, for example, constraints A and B described below.

Constraint A: The word class of a conversion source word is a particle or an auxiliary verb.

Constraint B: The word class of the conversion source word and the word class of a conversion destination word are different.

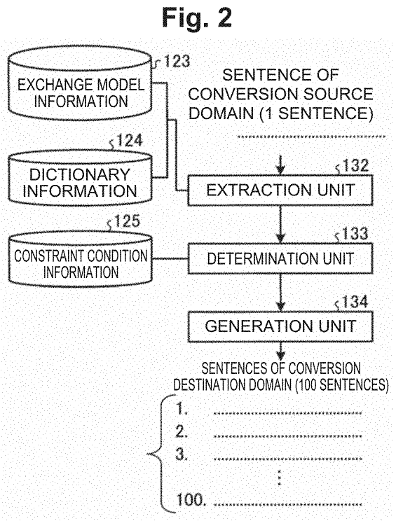

The control unit 13 controls the whole generation apparatus 10. The control unit 13 is, for example, an electronic circuit such as a CPU (central processing unit) or an MPU (micro processing unit) or an integrated circuit such as ASIC (application specific integrated circuit) or an FPGA (field programmable gate array). Further, the control unit 13 has an internal memory for storing programs defining various kinds of process procedures and control data, and executes each process using the internal memory. Further, the control unit 13 functions as various kinds of processing units by the various kinds of programs operating. For example, the control unit 13 has a learning unit 131, an extraction unit 132, a determination unit 133 and a generation unit 134. Here, details of each unit included in the control unit 13 will be explained with reference to FIG. 2. FIG. 2 is a diagram illustrating a flow of a process of the generation apparatus.

The learning unit 131 performs learning of a language model using the conversion destination domain text data 121. The learning unit 131 stores information such as parameters of the learned language model into the storage unit 12 as the language model information 122.

The extraction unit 132 extracts a second word corresponding to a first word included in first text from among a plurality of words belonging to a predetermined domain. As shown in FIG. 2, the extraction unit 132 inputs a sentence of a conversion source domain to an exchange model constructed based on the exchange model information 123. Then, based on an output result of the exchange model, the extraction unit 132 extracts candidate words from a plurality of words included in the dictionary information 124. The conversion source sentence is an example of the first text.

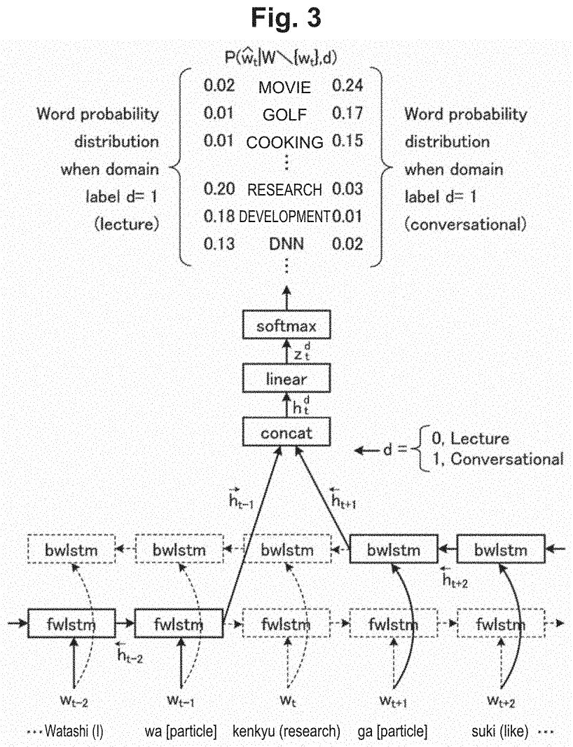

The extraction unit 132 extracts the words using a bidirectional LSTM as the exchange model (Reference Literature 1: S. Kobayashi, “Contextual augmentation: Data augmentation by words with paradigmatic relations,” in Proc. NAACL-HLT, 2018, pp. 452-457). FIG. 3 is a diagram illustrating the bidirectional LSTM. As shown in FIG. 3, the extraction unit 132 extracts words obtained by inputting the first text to the bidirectional LSTM together with a label specifying a domain, as the second word.

The exchange model estimates domain-dependent word probability distribution at time t=1, . . . , T when text W=w_{1:T}=w₁, . . . , w_{T} with a length of T is given. First, the extraction unit 132 generates a forward partial word string w_{1:t-1}=w₁, . . . , wₜ₋₁ and a backward partial word string w_{T:t+1}=w₁, . . . , wₜ₋₁ for the time t from the given text and give them to the exchange model. The exchange model recursively estimates hidden state vectors from the forward partial word string and the backward partial word string at a fwlstm (forward LSTM) layer and a bwlstm (backward LSTM) layer, and obtains hidden state vectors at time t−1 and time t+1 like Expression (1) and Expression (2), respectively.

[Math1]

\vec{h}ₜ₋₁=fwlstm(wₜ₋₁,\vec{h}ₜ₋₂) (1)

[Math2]

\vec{h}ₜ₊₁=hwistm(wₜ₊₁,\vec{h}ₜ₊₂) (2)

Furthermore, the exchange model couples the hidden state vectors and a scalar value d at a concat layer like Expression (3).

[Math3]

hₜ^{d}=concat(\vec{h}ₜ₋₁,\vec{h}ₜ₊₁,d) (3)

Here, d indicates domain labels of two values. In the present specification, explanation will be made on the assumption that d=0 indicates Lecture, and d=1 indicates Conversation. Further, here, it is assumed that d=0 indicates a conversion source domain, and d=1 indicates a conversion destination domain. Further, h^{d}ₜ indicates a domain-dependent hidden state vector at the time t. Furthermore, the exchange model inputs h^{d}ₜ to a linear layer, which is the first layer, and obtains z^{d}ₜ like Expression (4). Furthermore, the exchange model inputs z^{d}ₜ to a softmax layer and obtains domain-dependent word probability distribution P at the time t like Expression (5).

[Math4]

zₜ^{d}=linear(hₜ^{d}) (4)

[Math5]

P(ŵ₁|W(wₜ),d)=softmax(zₜ^{d})_{idx(ŵt)} (5)

Here, ^{∧}wₜ indicates a predicted word at the time t. Further, idx(^{∧}wₜ) indicates an index of ^{∧}wₜ in the dictionary information 124. Further, WY{wₜ} indicates a word string obtained by excluding wₜ from a sentence W (here, Y indicates a backslash).

It is assumed that learning of the exchange model is performed using learning data of both of the conversion-source and conversion-destination domains. In the learning of the exchange model, pre-learning without using a domain label is performed first, and then fine-tuning using a domain label is performed. By the learning using the domain labels, the exchange model acquires a domain-dependent wording. For example, when a forward partial word string w_{1:t-1}={ . . . , Watashi (I), wa [particle]} and a backward partial word string w_{T:t+1} { . . . , suki (like), ga [particle]} are given as shown in FIG. 3, high probabilities are given to words such as “research”, “development” and “DNN” at the time t in the case of d=0 (the domain is Lecture), and, on the contrary, high probabilities are given to words such as “movie”, “golf” and “cooking” in the case of d=1 (the domain is Conversation).

At the time of converting a sentence of the Lecture domain to a sentence of the Conversation domain, the extraction unit 132 inputs a sentence of the Lecture domain (d=0) to the exchange model and specifies a conversion destination domain label to Conversation (d=1). Thereby, it becomes possible to generate, based on the input sentence of the Lecture domain, a sentence in which, a word at each time is changed from a Lecture domain word to a Conversation domain word.

At this time, if the extraction unit 132 selects a maximum likelihood word from word probability distribution at each time, only one Conversation domain sentence can be generated from one Lecture domain sentence, and it is not possible to reinforce data. Therefore, in order to reinforce data by generating a plurality of Conversation domain sentences from one Lecture domain sentence, the extraction unit 132 introduces a sampling method based on Gumbel-max trick.

Specifically, the extraction unit 132 samples values corresponding to a vocabulary size from Gumbel distribution, and selects a maximum likelihood word from new distribution obtained by adding the values to word probability distribution estimated by the exchange model. By performing this sampling a plurality of times, the extraction unit 132 can generate a plurality of Conversation domain sentences from one Lecture domain sentence.

However, a preliminary experiment showed that, even though text generated using words obtained by the above procedure is used as learning data of a language model, neither reduction in perplexity of the language model nor improvement of speech recognition accuracy is obtained. Furthermore, as a result of analysis, it was known that the cause is that grammatical correctness is not ensured by a generated sentence.

Therefore, in order to ensure grammatical correctness of a generated sentence, the generation apparatus 10 of the present embodiment generates text using words determined to satisfy condition by the determination unit 133. The determination unit 133 determines whether predetermined condition for the word class of the first word is satisfied or not. As shown in FIG. 2, the determination unit 133 refers to the constraint condition information 125 to perform the determination.

If the word class of the first word is a word class specified in advance, and the word class of the first word and the word class of the second word are the same, the determination unit 133 determines that the predetermined condition for the word class of the first word is satisfied. In FIG. 3, “research”, which is a word at the time t in the conversion source sentence, is an example of the first word. Further, there is a strong possibility that “movie”, “golf”, “cooking” or the like with a high probability, among words of the Conversation domain, becomes the second word. However, depending on the content of the conversion source sentence or the performance of the exchange model, any word of any word class belonging to the Lecture domain can become the second word.

For example, when the constraints A and B described before are adopted, the determination unit 133 determines that the above condition is satisfied if the word class of the first word is neither a particle nor an auxiliary verb, and the word class of the first word and the word class of the second word are the same. For example, when a conversion source sentence is in Japanese, the determination unit 133 can apply such condition.

When it is determined by the determination unit 133 that the condition is satisfied, the generation unit 134 generates second text in which the first word of the first text is exchanged with the second word. By exchanging at least a part of words of the first text, the generation unit 134 generates the second text.

The determination unit 133 and the generation unit 134 may return such text that does not satisfy the condition of the constraint condition information 125 by post-processing. In this case, first, the generation unit 134 generates text of the conversion destination domain using words extracted by the extraction unit 132. Then, the determination unit 133 compares the generated text of the conversion destination domain with the conversion source text and determines whether, for positions at which word exchange has occurred, a conversion source word and a conversion destination word satisfy the condition or not. Then, if the determination unit 133 determines that the condition is not satisfied, the generation unit 134 performs a process of returning the conversion destination word at the relevant position to the conversion source word.

Further, the determination unit 133 may perform the determination before generation of text by the generation unit 134 so that, when it is determined by the determination unit 133 that the condition is not satisfied, the generation unit 134 does not perform exchange of words. Further, for example, as for the constraint A (the word class of a conversion source word is a particle or an auxiliary verb), since it is apparent from a conversion source word whether the condition is satisfied or not, the determination unit 133 may perform the determination before extraction of words by the extraction unit 132.

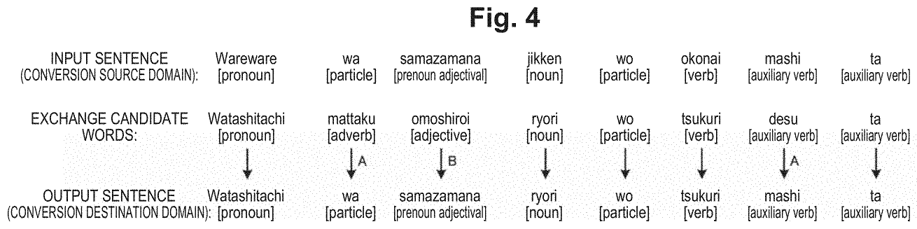

An example of a case of actually generating text using the constraints A and B will be explained using FIG. 4. FIG. 4 is a diagram illustrating determination of the condition. Here, when either the constraint A or the constraint B is satisfied, the determination unit 133 determines that condition for exchanging words is not satisfied. On the contrary, when neither the constraint A nor the constraint B is satisfied, the determination unit 133 determines that the condition for exchanging words is satisfied.

As shown in FIG. 4, a sentence of a conversion source domain is “Wareware (We) wa [particle] samazamana (various) jikken (experiments) wo [particle] okonai (perform) mashi [auxiliary verb] ta [auxiliary verb]”. It is assumed that, at this time, the extraction unit 132 has extracted words of “Watashitachi (We)”, “mattaku (quite)” “omoshiroi (interesting)”, “ryori (dish)”, “wo [particle]”, “tsukuri (make)”, “desu [auxiliary verb]” and “ta [auxiliary verb]” for “Wareware (We)”, “wa [particle]”, “samazamana (various)”, “jikken (experiments)”, “wo [particle]”, “okonai (perform)”, “mashi [auxiliary verb]” and “ta [auxiliary verb]”, respectively.

First, the word class of “Wareware (We)” is not a particle or an auxiliary verb but a pronoun. Further, both of “Wareware (We)” and “Watashitachi (We)” are pronouns. Therefore, the determination unit 133 determines that the condition is satisfied for exchanging “Wareware (We)” with “Watashitachi (We)”.

Next, the word class of “wa” is a particle. Therefore, the constraint A is satisfied, and the determination unit 133 determines that the condition is not satisfied for exchanging “wa [particle]” with “mattaku (quite)”.

Furthermore, the word class of “samazamana (various)” is not a particle or an auxiliary verb but a pre-noun adjectival. However, the word class of “omoshiroi (interesting)” is an adjective. Thus, since the word classes of “samazamana (various)” and “omoshiroi (interesting)” are different, the constraint B is satisfied, and the determination unit 133 determines that the condition is not satisfied for exchanging “samazamana (various)” with “omoshiroi (interesting)”.

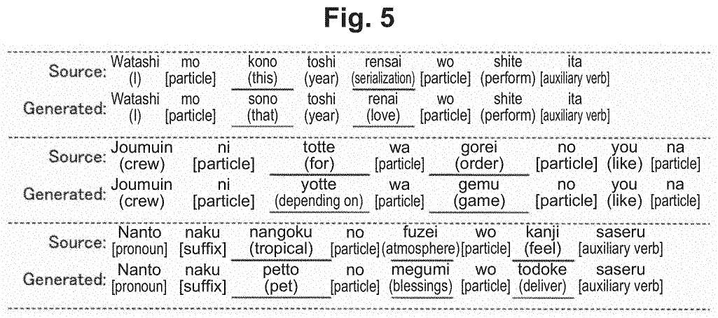

As a result, in response to the determination result by the determination unit 133, the generation unit 134 generates an output sentence of “Watashitachi (We) wa [particle] samazamana (various) ryori (dishes) wo [particle] tsukuri (make) mashi [auxiliary verb] ta [auxiliary verb] in the end. FIG. 5 is a diagram showing examples of an input sentence and an output sentence. In FIG. 5. Source indicates conversion source text, and Generated indicates text generated by the generation unit 134.

### Flow of Process of First Embodiment

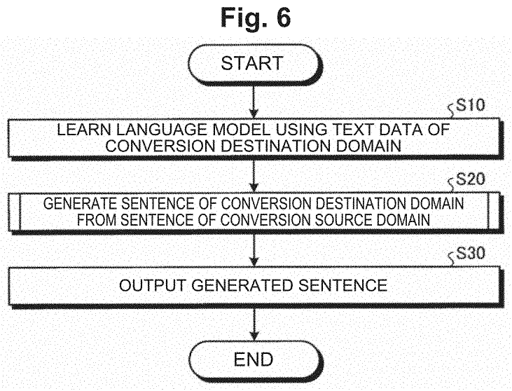

FIG. 6 is a flowchart showing a flow of the process of the generation apparatus according to the first embodiment. First, the generation apparatus 10 learns a language model using text data of a conversion destination domain (step S10). Next, the generation apparatus 10 generates a sentence of a conversion destination domain from a sentence of a conversion source domain (step S20). Then, the generation apparatus 10 outputs the generated sentence (step S30).

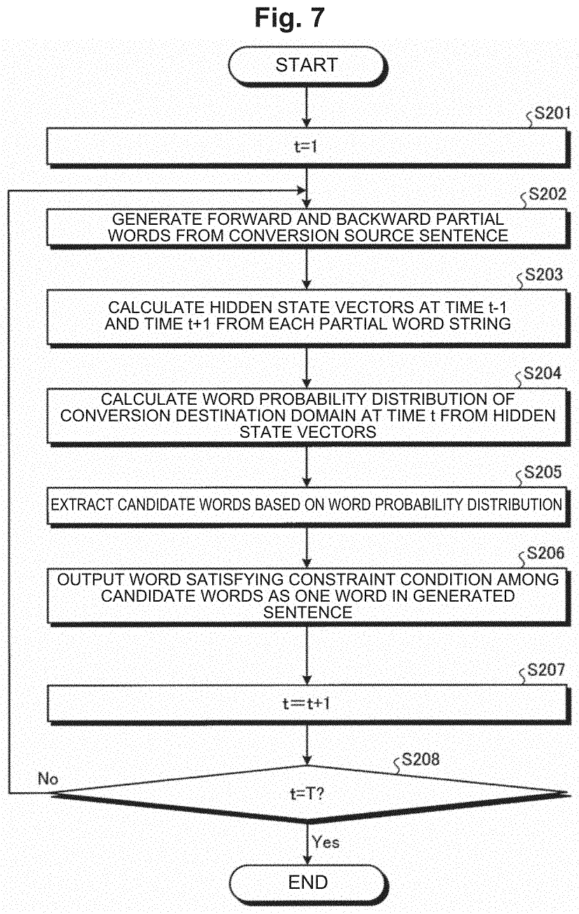

A flow of the process of the generation apparatus 10 generating a sentence (S20 of FIG. 6) will be explained using FIG. 7. FIG. 7 is a flowchart showing the flow of the sentence generation process. As shown in FIG. 7, the generation apparatus 10 sets the initial value of t to 1 first (step S201).

Next, the generation apparatus 10 generates forward and backward partial word strings from a conversion source sentence (S202). Then, the generation apparatus 10 calculates hidden state vectors at time t−1 and time t+1 from each partial word string (step S203). Furthermore, the generation apparatus 10 calculates word probability distribution of the conversion destination domain at time t from the hidden state vectors (step S204).

Here, the generation apparatus 10 extracts candidate words based on the word probability distribution (step S205). Then, the generation apparatus 10 outputs a word satisfying the constraint condition, among the candidate words, as one word in a generated sentence (step S206). Furthermore, the generation apparatus 10 increases t by 1 (step S207). If t has reached a length T of the conversion source sentence (step S208: Yes), the generation apparatus 10 ends the process. On the other hand, if t has not reached the length T (step S208: No), the generation apparatus 10 returns to step S202 and repeats the process.

### Effect of First Embodiment

As explained so far, the extraction unit 132 extracts a second word corresponding to a first word included in first text from among a plurality of words belonging to a predetermined domain. The determination unit 133 determines whether predetermined condition for the word class of the first word is satisfied or not. When it is determined by the determination unit 133 that the condition is satisfied, the generation unit 134 generates second text in which the first word of the first text is exchanged with the second word. Thus, if there is a word of a domain for which learning data is to be reinforced, the generation apparatus 10 can automatically generate text data of the domain. Therefore, according to the present embodiment, it is possible to perform such reinforcement of learning data that enhances accuracy of a language model.

If the word class of the first word is a word class determined in advance, and the word class of the first word and the word class of the second word are the same, the determination unit 133 determines that the condition is satisfied. It is conceivable that, if the word class is carelessly changed at the time of exchanging words, the text may grammatically break down. In the present embodiment, it is possible to, by specifying condition for word classes, prevent converted text from being grammatically incorrect.

If the word class of the first word is neither a particle nor an auxiliary verb, and the word class of the first word and the word class of the second word are the same, the determination unit 133 determines that the condition is satisfied. Especially in the case of Japanese, it is conceivable that, if a particle or an auxiliary verb is carelessly changed, the text may grammatically break down. In the present embodiment, by preventing a particle and an auxiliary verb from being exchanged, it is possible to prevent converted text from being grammatically incorrect.

The extraction unit 132 extracts a plurality of words for one first word as the second word by adding a plurality of values sampled from Gumbel distribution to probability distribution of a plurality of words belonging to a predetermined domain. Therefore, according to the present embodiment, it is possible to generate a plurality of texts of a desired domain from one piece of text.

[Experiment Result]

An experiment for verifying effectiveness of the first embodiment will be explained. In the experiment, the CSJ lecture speech corpus (Reference Literature 2: K. Maekawa, “Corpus of spontaneous Japanese: its design and evaluation,” in Proc. Workshop on Spontaneous Speech Processing and Recognition (SSPR), 2003, pp. 7-12) (hereinafter, CSJ) was used as text data of a conversion source domain. Further, NTT Meeting (free conversation by multiple people) Speech Corpus (Reference Literature 3: T. Hori, S. Araki, T. Yoshioka, M. Fujimoto, S. Watanabe, T. Oba, A. Ogawa, K. Otsuka, D. Mikami, K. Kinoshita, T. Nakatani, A. Nakamura, and J. Yamato, “Low-latency real-time meeting recognition and understanding using distant microphones and omni-directional camera,” IEEE TASLP, vol. 20, no. 2, pp. 499-513, February 2012) (hereinafter, NTT) was used as text data of a conversion destination domain.

In the experiment, by the method of the embodiment, CSJ was converted to the NTT conversation domain, and five pieces of data the amounts of which are 1 time, 10 times, 20 times, 50 times and 100 times were generated (expressed as GenCSJx{1, 10, 20, 50, 100}).

Further, seven trigram language models were learned using NTT, CSJ and GenCSJx{1, 10, 20, 50, 100}, respectively (hereinafter, the trigram language models are referred to according to the learning data name). In addition, a trigram language model obtained by performing weighted addition of NTT and CSJ based on PPL for NTT development data (NTT+CSJ; weights: 0.3:0.7) and a trigram language model obtained by performing weighted addition of NTT, CSJ and GenCSJx100 (NTT+CSJ+GenCSJx100; weighs: 0.5:0.2:0.3) were created (for a weight calculation procedure, see Non-Patent Literatures 1 and 2).

Then, PPLs, OOVs (out-of-vocabulary rates: unknown word rates) and WERs (word error rates) for both of NTT development data and evaluation data of the above nine trigram models were determined. For all of PPLs, OOVs and WERs, a smaller value indicates better accuracy.

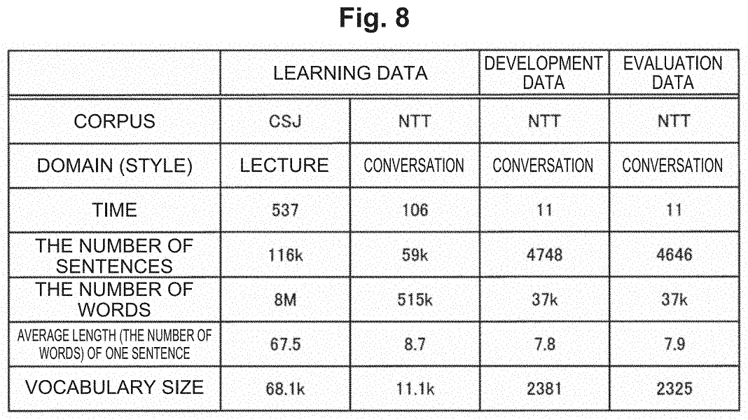

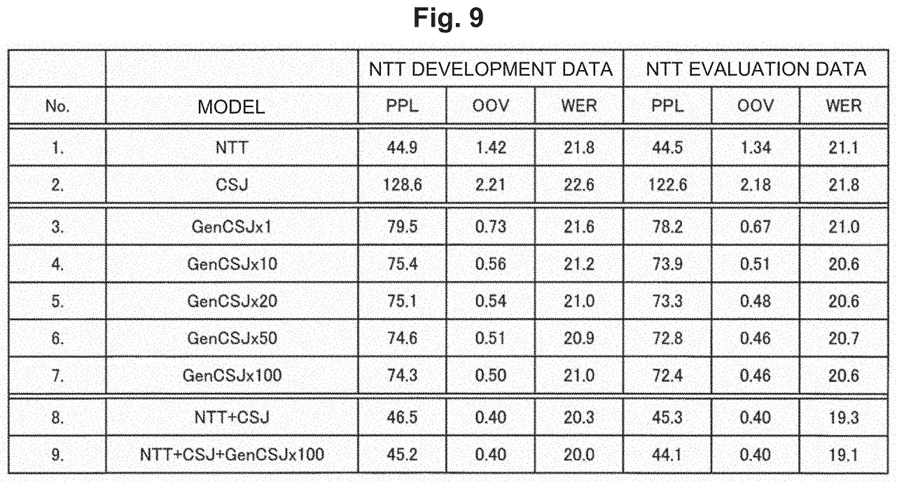

FIG. 8 is a diagram showing a result of the experiment. FIG. 9 is a diagram showing details of datasets. By comparison between 2. CSJ and 3. to 7. GenCSJx{1, 10, 20, 50, 100} in FIG. 8, effectiveness of the proposed method can be confirmed (in comparison with 2., lower PPLs, OOVs and WERs are shown for 3. to 7.) As a result of comparing pieces of data of 2. CSJ and 3. GenCSJx1, it was known that 22.5% of words have been exchanged. Furthermore, in comparison with 1. NTT, 3. to 7. show lower OOV and WER values though showing higher PPL values. Further, by comparison among 3. to 7., the effectiveness of generating a large amount of data can be confirmed. By comparison between 8. NTT+CSJ and 9. NTT+CSJ+GenCSJx100, it can be confirmed that final WER reduction is obtained by the proposed method.

### SECOND EMBODIMENT

In the first embodiment, there may be a case where text that is grammatically correct but cannot be said to be semantically correct, such as “Nanto [pronoun] naku [suffix] petto (pet) no [particle] megumi (blessings) wo [particle] todoke (deliver) saseru [auxiliary verb]” is generated as shown in the third stage in FIG. 5. This is because each exchange of words is independently performed without consideration of the context of the words. Therefore, in the second embodiment, a generation apparatus further narrows down generated text in consideration of semantic correctness.

### Configuration of Second Embodiment

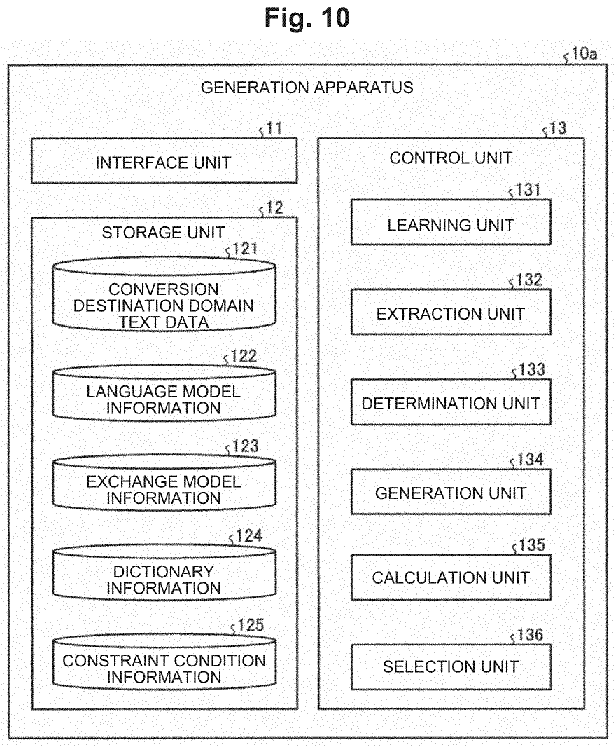

A configuration of the generation apparatus according to the second embodiment will be explained using FIG. 10. FIG. 10 is a diagram showing a configuration example of the generation apparatus according to the second embodiment. In FIG. 10, parts similar to those of the first embodiment will be given the same reference signs as FIG. 1 and the like, and explanation thereof will be omitted. As shown in FIG. 10, a generation apparatus 10a has a calculation unit 153 and a selection unit 136 in addition to processing units similar to those of the generation apparatus 10 of the first embodiment.

The calculation unit 135 calculates PPL (perplexity) of each of a plurality of second texts generated by the generation unit 134, using a language model. The language model may be constructed from the language model information 122. Then, the selection unit 136 selects such texts that lowness of the PPL calculated by the calculation unit satisfies a predetermined criterion, from among the plurality of second texts. For example, the selection unit 136 may select a piece of text with the lowest PPL or may select a predetermined number of texts in ascending order of PPL.

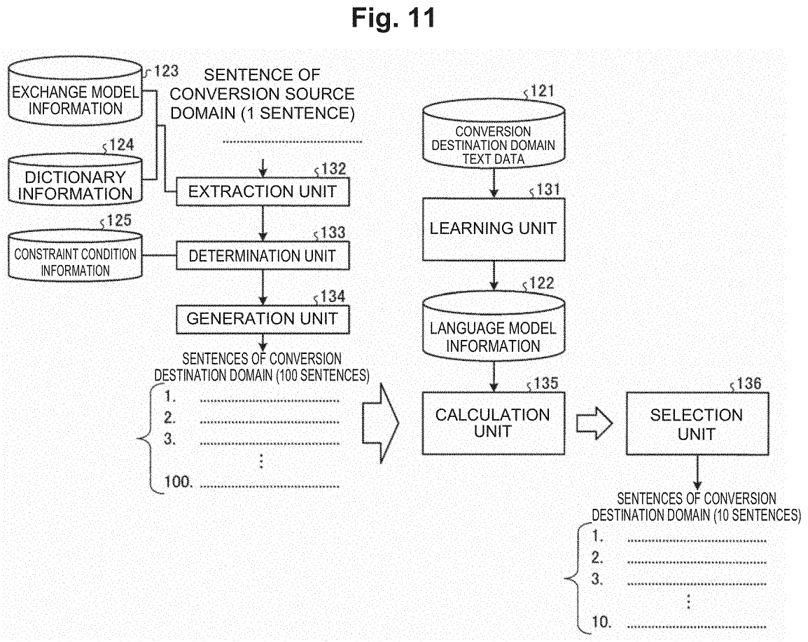

FIG. 11 is a diagram illustrating a flow of a process of the generation apparatus. In the example of FIG. 11, it is assumed that the generation unit 134 generates one hundred sentences similarly to the first embodiment. Then, the calculation unit 135 calculates PPL for each of the one hundred sentences using the learned language model. Furthermore, the selection unit 136 selects ten sentences from among the one hundred sentences generated by the generation unit 134 in ascending order of PPL.

### Flow of Process of Second Embodiment

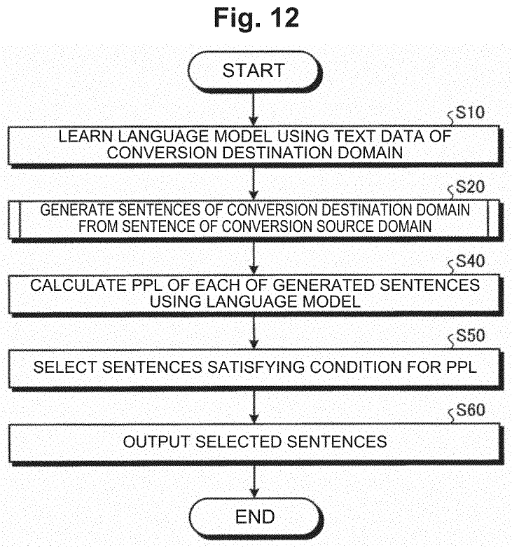

FIG. 12 is a flowchart showing the flow of the process of the generation apparatus according to the second embodiment. First, the generation apparatus 10 learns a language model using text data of a conversion destination domain (step S10). Next, the generation apparatus 10 generates sentences of a conversion destination domain from a sentence of a conversion source domain (step S20).

Here, the generation apparatus 10 calculates PPL of each of the generated sentences using the language model (step S40). Furthermore, the generation apparatus 10 selects sentences satisfying condition for PPL from among the generated sentences (step S50). Then, the generation apparatus 10 outputs the selected sentences (step S60).

### Effect of Second Embodiment

As explained so far, the calculation unit 135 calculates PPL (perplexity) of each of a plurality of second texts generated by the generation unit 134, using a language model. The selection unit 136 selects such texts that lowness of PPL calculated by the calculation unit satisfies a predetermined criterion, from among the plurality of second texts. It shows that words are reasonably connected, that is, the text is semantically correct that PPL is low. Therefore, according to the present embodiment, it is possible to obtain text that is grammatically correct and semantically correct.

### Other Embodiments

The constraint condition may differ according to the language of text. For example, if the language of text is English or the like, the determination unit 133 can determine that the condition is satisfied if the word class of a first word is neither a particle (an indeclinable, a diminutive, a prefix or a suffix) nor an auxiliary verb, and the word class of the first word and the word class of a second word are the same.

[System Configuration and the Like]

Each component of each apparatus shown in the drawings is functionally conceptual and is not necessarily required to be physically configured as shown in the drawings. That is, a specific distribution/integration form of each apparatus is not limited to that shown in the drawings. Each apparatus can be entirely or partially configured by functional or physical distribution or integration in an arbitrary unit according to various kinds of loads, the usage situation and the like. Furthermore, as for each processing function performed in each apparatus, all or an arbitrary part thereof can be realized by a CPU and a program analyzed and executed by the CPU or can be realized as hardware by wired logic.

Further, among the processes explained in each of the present embodiments, all or a part of a process explained as being automatically performed can be manually performed or all or a part of a process explained as being manually performed can be automatically performed by a publicly known method. In addition, the processing procedures, the control procedures, the specific names, the information including various kinds of data and parameters shown in the above document and the drawings can be arbitrarily change unless otherwise specified.

[Program]

As one embodiment, the generation apparatus 10 can be implemented by causing a generation program to execute the above generation process to be installed into a desired computer as packaged software or online software. For example, by causing an information processing apparatus to execute the above generation program, it is possible to cause the information processing apparatus to function as the generation apparatus 10. As the information processing apparatus stated here, a desktop or notebook personal computer is included. In addition, a smartphone, a mobile phone, a mobile communication terminal such as a PHS (personal handyphone system) and a slate terminal such as a PDA (personal digital assistant) and the like are also included in the category of the information processing apparatus.

Further, by causing terminal apparatuses used by users to be clients, the generation apparatus 10 can be implemented as a generation server apparatus to provide services related to the generation process to the clients. For example, the generation server apparatus is implemented as a server apparatus to provide a generation service with text of a conversion source domain as an input and text of a conversion destination domain as an output. In this case, the generation server apparatus may be implemented as a web server or may be implemented as a cloud to provide the services related to the above generation process by outsourcing.

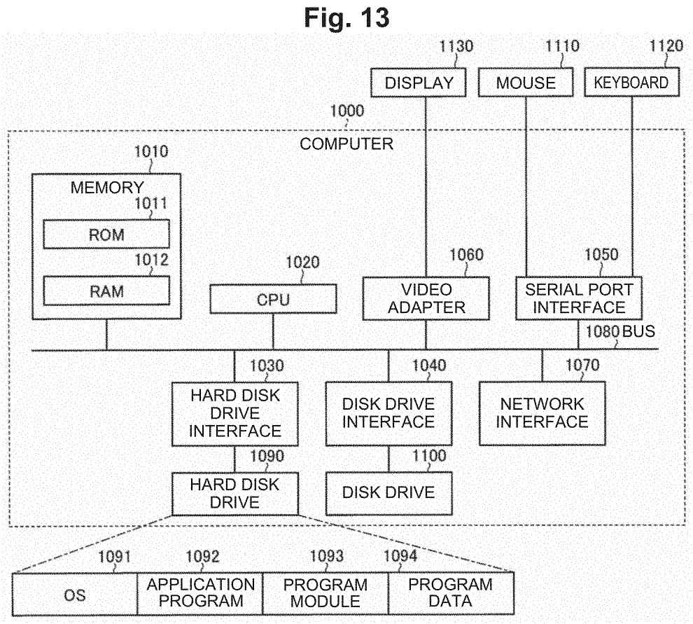

FIG. 13 is a diagram showing an example of a computer to execute the generation program. A computer 1000 includes, for example, a memory 1010 and a CPU 1020. Further, the computer 1000 includes a hard disk drive interface 1030, a disk drive interface 1040, a serial port interface 1050, a video adapter 1060 and a network interface 1070. These units are connected via a bus 1080.

The memory 1010 includes a ROM (read-only memory) 1011 and a RAM 1012. The ROM 1011 stores, for example, a boot program such as BIOS (basic input output system). The hard disk drive interface 1030 is connected to a hard disk drive 1090. The disk drive interface 1040 is connected to a disk drive 1100. A removable storage medium, for example, a magnet disk, an optical disk or the like is inserted into the disk drive 1100. The serial port interface 1050 is connected, for example, to a mouse 1110 and a keyboard 1120. The video adapter 1060 is connected, for example, to a display 1130.

The hard disk drive 1090 stores, for example, an OS 1091, an application program 1092, a program module 1093 and program data 1094. That is, a program specifying each process of the generation apparatus 10 is implemented as the program module 1093 in which a computer-executable code is written. The program module 1093 is stored, for example, in the hard disk drive 1090. For example, the program module 1093 for executing processes similar to those of the functional components of the generation apparatus 10 is stored in the hard disk drive 1090. An SSD may substitute for the hard disk drive 1090.

Further, setting data used in the processes of each of the embodiments described above is stored, for example, in the memory 1010 or the hard disk drive 1090 as the program data 1094. The CPU 1020 reads out the program module 1093 and the program data 1094 stored in the memory 1010 or the hard disk drive 1090 to the RAM 1012 as necessary to execute the processes of each of the embodiments described above.

The program module 1093 and the program data 1094 are not limited to the case of being stored in the hard disk drive 1090 but may be stored, for example, in a removable storage medium and read out by the CPU 1020 via the disk drive 1100 or the like. Or alternatively, the program module 1093 and the program data 1094 may be stored in another computer connected via a network (a LAN (local area network), a WAN (wide area network) or the like). Then, the program module 1093 and the program data 1094 may be read out from the other computer by the CPU 1020 via the network interface 1070.

### REFERENCE SIGNS LIST

10, 10a Generation apparatus
11 Interface unit
12 Storage unit
13 Control unit
121 Conversion destination domain text data
122 Language model information
123 Exchange model information
124 Dictionary information
125 Constraint condition information
131 Learning unit
132 Extraction unit
133 Determination unit
134 Generation unit
135 Calculation unit
136 Selection unit

1. A generation apparatus, comprising:
extraction circuitry extracting a second word corresponding to a first word included in a first text from among a plurality of words belonging to a predetermined domain;
determination circuitry determining whether a predetermined condition for a word class of the first word is satisfied or not; and
generation circuitry generating a second text in which the first word of the first text is exchanged with the second word when it is determined by the determination circuitry that the condition is satisfied.

2. The generation apparatus according to claim 1, wherein;
if the word class of the first word is a word class determined in advance, and the word class of the first word and a word class of the second word are the same, the determination circuitry determines that the condition is satisfied.

3. The generation apparatus according to claim 1, wherein;
if the word class of the first word is neither a particle nor an auxiliary verb, and the word class of the first word and the word class of the second word are the same, the determination circuitry determines that the condition is satisfied.

4. The generation apparatus according to claim 1, wherein;
if the word class of the first word is neither a particle nor an auxiliary verb, and the word class of the first word and the word class of the second word are the same, the determination circuitry determines that the condition is satisfied.

5. The generation apparatus according to claim 1, wherein;
the extraction circuitry extracts a plurality of words for the one first word as the second word by adding a plurality of values sampled from Gumbel distribution to probability distribution of the plurality of words belonging to the predetermined domain.

6. The generation apparatus according to claim 1, further comprising:
a calculation circuitry calculating PPL (perplexity) of each of a plurality of second texts generated by the generation circuitry, each second text recited in claim 1, using a language model; and
a selection circuitry selecting such texts that lowness of the PPL calculated by the calculation circuitry satisfies a predetermined criterion, from among the second texts.

7. A generation method, comprising:
extracting a second word corresponding to a first word included in a first text from among a plurality of words belonging to a predetermined domain;
determining whether a predetermined condition for a word class of the first word is satisfied or not; and
generating a second text in which the first word of the first text is exchanged with the second word when the determining determines that the condition is satisfied.

8. A non-transitory computer readable medium including a generation program for causing a computer to perform the method of claim 7.
